(19) United States
(12) Patent Application Publication
(10) Pub. No.: US 2016/0364435 A1
(43) Pub. Date: Dec. 15, 2016

(54) GENERATING A NEW SYNTHETIC DATASET LONGITUDINALLY CONSISTENT WITH A PREVIOUS SYNTHETIC DATASET

(71) Applicants: ADI, LLC, Rochester, NY (US); Exact Data, LLC, Scottsville, NY (US)

(72) Inventors: Mitchell R. Rosen, Rochester, NY (US); Gary A. Passero, Rochester, NY (US); Joshua David Glasser, Pittsford, NY (US); Douglass Huang, Fairport, NY (US); James K. McGarity, Avon, NY (US); David T. Dreyer, Rochester, NY (US); Steven P. Spiwak, Webster, NY (US); E. Todd Johnsson, Fairport, NY (US); Thomas M. Hager, Rochester, NY (US)

(21) Appl. No.: 15/181,014

(22) Filed: Jun. 13, 2016

Related U.S. Application Data
(60) Provisional application No. 62/175,122, filed on Jun. 12, 2015.

(51) Int. Cl. G06F 17/30

(52) U.S. Cl. CPC G06F 17/30371; G06F 17/30424

(57) ABSTRACT

A second synthetic dataset is generated having internal consistencies with a previously generated first synthetic dataset. The synthetic data of the second dataset can be generated based on a set of rules loaded into a computer data generator for defining entities and interrelationships among events associated with the entities consistent with at least some of the rules previously used for generating the first synthetic dataset. Entities and historical information about the entities within a first observation spanning a first time period can be derived from the first synthetic dataset stored in a computer-readable memory. A second observation window can be established spanning a second time period that is different from the first time period. The computer data generator can be used for generating new synthetic data about the entities from the first synthetic dataset within the second observation window based on the rules loaded into the data generator and the historical information extracted from the first synthetic dataset. The new synthetic data in the second synthetic dataset can be arranged in a form for loading into a data processing system intended for testing using the second synthetic dataset.

### TECHNICAL FIELD

The invention relates generally to the ongoing testing, demonstrating, training or the like of data processing systems with synthetic data having time-based relationships among dataset artifacts and to the evolution of at least portions of the synthetic data for extending or otherwise expanding the time-based relationships to generate new synthetic data that maintains desired continuities for producing comparable results.

### BACKGROUND

Data processing systems for processing event-based data, such as in health care claims processing systems, operate according to complex internal rules for both internal and external uses such as in the recognition of data trends or processing of individual claims. Large synthetic datasets that are suitably realistic allow for measuring or otherwise testing such data processing systems against performance goals and intentions for the processing systems.

Such synthetic datasets differ from actual datasets because the rules of their construction are predefined and the correct results for processing this data on an individual case or aggregate basis are known or readily derivable. Rather than merely assembling data in some form of organization, synthetic datasets are constructed according to complex sets of rules that interrelate the data in ways that could only be inferred from actual datasets.

Ideally, with respect to the system under test (SUT), the synthetic datasets are indistinguishable from the actual datasets normally processed by the SUT so that proper extrapolations can be made concerning the processing of actual data. However, in contrast to the actual datasets, a wide range of additional information is known about the synthetic datasets based on their rules of construction.

Often, criteria for realism include temporal longitudinality, meaning that there are believable time-based relationships among dataset artifacts. For example, a first step for generating a synthetic dataset might involve creating a hypothetical set of entities, each of which is assigned a specific set of characteristics and relevant past history. Subsequent steps might include stepping through time across a temporal observation window, utilizing heuristics based on individual and aggregate histories and intrinsic likelihoods to determine how and when an entity undergoes an action that requires the production of artifacts of interest to the SUT. Each action is itself a potential modification of the entity's history and could impact future heuristics that involve that and other entities.

Once a synthetic dataset has been generated for a particular SUT, it is common for a testing or development organization to maintain such datasets, as they are valuable test objects that help speed up SUT development. These may be reused on the same system after the SUT undergoes an update, they may be applied to alternate SUTs or used to test other aspects of the original system. Should the synthetic dataset remain static, there are many reasons why it could lose relevancy for the purposes of testing new or updated SUTs ranging from stale dates within the dataset to inadequacies of artifacts to meet new testing requirements. However, there is often strong resistance from the testing or development organization to the wholesale replacement of an already installed synthetic dataset. Testers become familiar with specific idiosyncrasies of the synthetic dataset artifacts and can form a reliance on such dataset particulars. Also, there can be high costs and other complexities associated with the deletion and loading of entirely new datasets, especially if they are very large. Being able to produce a new synthetic dataset that is longitudinally consistent with the existing dataset is thus an important feature for a synthetic data generator to have, constituting a fundamental improvement in the synthetic dataset.

As an example, say a company is building an Electronic Healthcare Records (EHR) system. The actual dataset might contain specific healthcare providers, patients, clinics, hospitals, and insurance companies. If this actual dataset were to be mimicked by a synthetic dataset, then characteristics of each fictional entity in the synthetic dataset would be generated according to realistic parameters to the extent that is appropriate for a given test regime. Testers may come to rely on particular fictional patients in the first test dataset due to their specific ailments or specific situations. Perhaps testers gets to know which fictional patients are chronic smokers, or they rely on a fact that particular providers refuse Medicaid patients, or they find a household where the bread-winner started Workman's Compensation while the spouse was undergoing physical therapy for a replaced shoulder. Perhaps the dates in the first dataset span from Jul. 1, 2005 to Jun. 30, 2010. Now, the EHR system is being updated. They want to test their updated system and its new capabilities. The testing organization will want new medical encounters for the same healthcare providers, patients, clinics, hospitals, and insurance companies but spanning the time from Jul. 1, 2010 to Jun. 30, 2015. They will want all the characteristics of those entities to stay the same, same ID numbers, same addresses and same relationships. The testing organization may have new requirements for realism, may need to see new types of ailments, new healthcare provider specialties or new patient behaviors, but they do not want the existing dataset to be unduly disturbed.

New synthetic datasets consistent with existing datasets do not require that longitudinal dates of the two datasets be contiguous. In the example above where the first dataset has an observed date range of Jul. 1, 2005 to Jun. 30, 2010, perhaps the testing organization might wish to evaluate a utility that was only to be used on records generated after Jan. 1, 2012. In that case, a new dataset consisting of dates between Jan. 1, 2012 and Jun. 30, 2015 would make sense, even when there was also a requirement that the new dataset be consistent with the first dataset, which ended in 2010. Likewise, a new EHR utility could be intended to only impact records generated prior to the year 2000. That would call for a newly generated dataset ending Dec. 30, 1999, yet consistent with the first set.

### SUMMARY OF INVENTION

The various embodiments disclosed herein include a method of generating a second synthetic dataset having internal consistencies with a previously generated first synthetic dataset. For example, a set of rules can be loaded into a computer data generator for defining entities and interrelationships among events associated with the entities consistent with at least some of the rules previously used for generating the first synthetic dataset. Entities and historical information about the entities can be derived from the first synthetic dataset stored in a computer-readable memory, which historical information is generated within a first observation window spanning a first time period. A second observation window can be established spanning a second time period that is different from the first time period. The computer data generator can be used for generating new synthetic data about the entities from the first synthetic dataset within the second observation window based on the rules loaded into the data generator and the historical information extracted from the first synthetic dataset. The new synthetic data in the second synthetic dataset can be arranged in a form for loading into a data processing system intended for testing using the second synthetic dataset. The second synthetic dataset as so arranged can include both test data intended to be processed by the data processing system and metadata defining interrelationships among the test data for evaluating performance of the data processing system.

The first and second observation windows can span contiguous, temporally separated, or overlapping intervals of time. For contiguous observation windows, the second synthetic dataset can provide a temporal extension of the first synthetic dataset such that at a start of the second observation window, at least a subset of the entities in the second synthetic dataset has characteristics that are consistent with events and histories present in the first synthetic dataset at an end of the first observation window. Alternatively, an end of the second observation window can be arranged to correspond to a beginning of the first observation window such that at an end of the second observation window, at least a subset of the entities in the second synthetic dataset has characteristics that are consistent with events and histories present in the first synthetic dataset at a start of the first observation window.

For first and second observation windows spanning temporally separated intervals of time, the first observation window can precede the second observation window, and at a start of the second observation window, at least a subset of the entities in the second synthetic dataset has characteristics that are consistent with events and histories present in the first synthetic dataset at an end of the first observation window. Alternatively, the second observation window can precede the first observation window, and at an end of the second observation window, at least a subset of the entities in the second synthetic dataset has characteristics that are consistent with events and histories present in the first synthetic dataset at a start of the first observation window.

For overlapping observation windows in which the second observation window overlaps a portion of the first observation window, the second synthetic dataset can replace synthetic data of the first synthetic dataset within the overlapping portion of the first and second observation windows. The second observation window can overlap a start of the first observation window, an end of the first observation window, or somewhere in between.

The entities within the second synthetic dataset can (a) exactly match the entities within the first synthetic dataset, (b) include a combination of new entities and at least a subset of the entities within the first synthetic dataset, (c) include a combination of new entities with all of the entities within the first synthetic dataset, or (d) include a subset of the entities with the first synthetic dataset with no additional entities.

In advance of generating the second synthetic dataset a set of rules previously used by a data generator for generating the first synthetic dataset can be saved into a computer-readable memory, and at least a portion of the set of rules can be loaded into the computer data generator for defining entities and interrelationships among events associated with the entities consistent with at least some of the rules previously used for generating the first synthetic dataset.

Additional synthetic data based on the synthetic data in at least one of the first and second synthetic datasets can be generated for new observation windows for temporally extending or updating synthetic data from at least one of the first or second synthetic data sets. For example, a third observation window can be established spanning a third time period that is different from the first and second time periods. The computer data generator can be used for generating additional new synthetic data about the entities from the at least one of the first and second synthetic datasets within the third observation window based on the rules loaded into the data generator and the historical information extracted from at least one of the first and second synthetic datasets. In addition, a further set of rules can be loaded into the computer data generator for defining entities and interrelationships among events associated with the entities consistent with at least some of the rules previously used for generating at least one of the first and second synthetic datasets. Entities and historical information about the entities can be derived from at least one of the first and second synthetic datasets stored in a computer-readable memory, which historical information is generated within at least one of the first and second observation windows.

The additional new synthetic data can be arranged in a third synthetic dataset in a form for loading into a data processing system intended for testing using the third synthetic dataset. The third synthetic dataset as so arranged can include both test data intended to be processed by the data processing system and metadata defining interrelationships among the test data for evaluating performance of the data processing system.

### BRIEF DESCRIPTION OF THE DRAWING FIGURES

FIG. 1 is a schematic diagram of a synthetic data generator for use with embodiments of the invention.

FIG. 2 is a flow chart of processing steps performed within a composition module.

FIG. 3 is a flow chart of processing steps performed within an evaluation module.

FIG. 4 is a flow chart of processing steps performed within a generation module.

FIG. 5 is a flow chart of processing steps performed within a transformation module.

FIG. 6 is a timeline showing contiguous first and second datasets generated in sequence with the observation window of the second dataset beginning at a time that the observation window of the first dataset ends.

FIG. 7 is a timeline showing temporally separated first and second datasets generated in sequence with the observation window of the second dataset beginning at a time after the observation window of the first dataset ends.

FIG. 8 is a timeline showing overlapping first and second datasets generated in sequence with the observation window of the second dataset beginning at a time before the observation window of the first dataset ends and ending at a time after the observation window of the first dataset ends.

FIG. 9 is a timeline showing contiguous first and second datasets generated in sequence with the observation window of the second dataset ending at a time that the observation window of the first dataset begins.

FIG. 10 is a timeline showing temporally separated first and second datasets generated in sequence with the observation window of the second dataset ending at a time before the observation window of the first dataset begins.

FIG. 11 is a timeline showing overlapping first and second datasets generated in sequence with the observation window of the second dataset beginning at a time before the observation window of the first dataset starts and ending at a time before the observation window of the first dataset ends.

FIG. 12 is a set diagram illustrating a situation where the population members of the first and second datasets exactly match.

FIG. 13 is a set diagram illustrating a situation where the second dataset includes all population members of the first dataset as well as new population members.

FIG. 14 is a set diagram illustrating a situation where the second dataset includes a subset of the population members of the first dataset and no new population members.

FIG. 15 is a set diagram illustrating a situation where the second dataset includes a subset of the population members of the first dataset as well as new population members.

### DETAILED DESCRIPTION

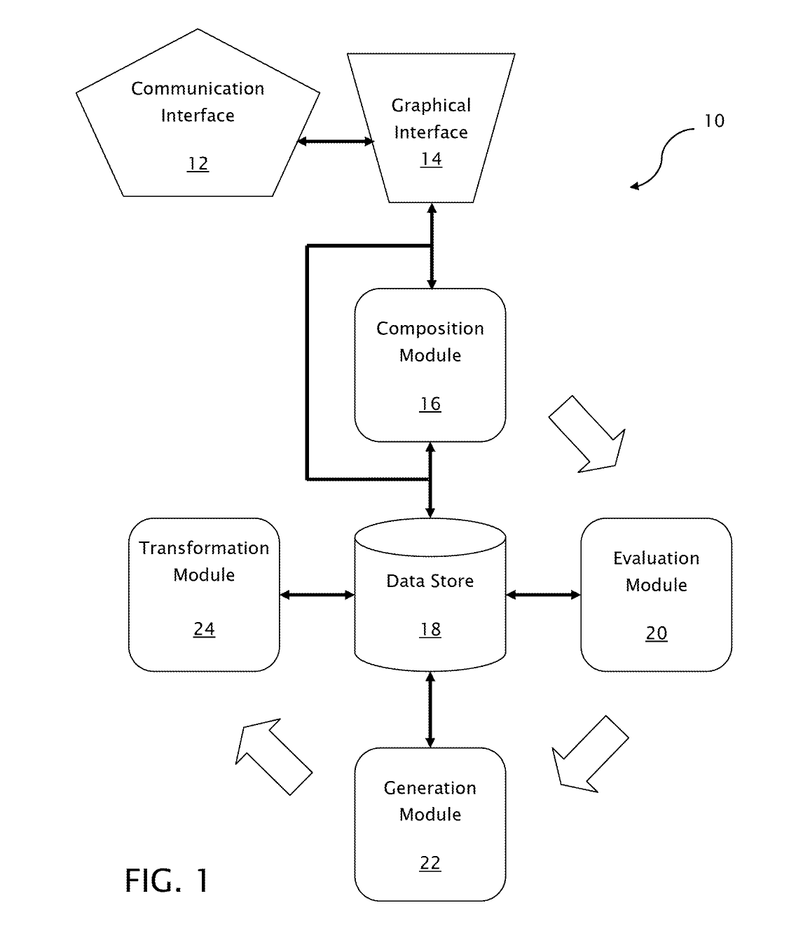

A synthetic data generator 10 of a type appropriate for generating synthetic datasets is laid out in FIG. 1. The synthetic data is intended to represent realistic data, conforming to statistically acceptable trends and exhibiting internal consistency. The system 10 is arranged for creating large sets of meaningful data for testing sophisticated document processing systems, which can include testing the performance of complex business rules, or data mining applications. Although realistic to the systems under test, the synthetic data can contain built-in anomalies that can be tracked through the system under test to gauge particular responses of the systems.

As shown in FIG. 1, the synthetic data generator 10 is accessible through a communication interface 12 using a standard web browsing client (e.g., Mozilla® Firefox® web browser, registered trademarks of Mozilla Foundation or Microsoft® Internet Explorer® web browser, registered trademarks of Microsoft Corporation). A graphical interface 14, accessible through the communication interface 12, communicates directly or indirectly through a composition module 16 to a data store 18, which preferably includes a server on which the synthetic data is stored. The composition module 16 guides users through the generation of new synthetic data by creating new data generation templates or by revising existing data generation templates. Once created and saved in the data store 18, the synthetic data can be downloaded for testing data processing or data mining applications. The synthetic data can be used directly as an electronic file, such as for testing processing systems for electronic data, or can be further converted into electronic or paper images, such as for testing forms processing systems.

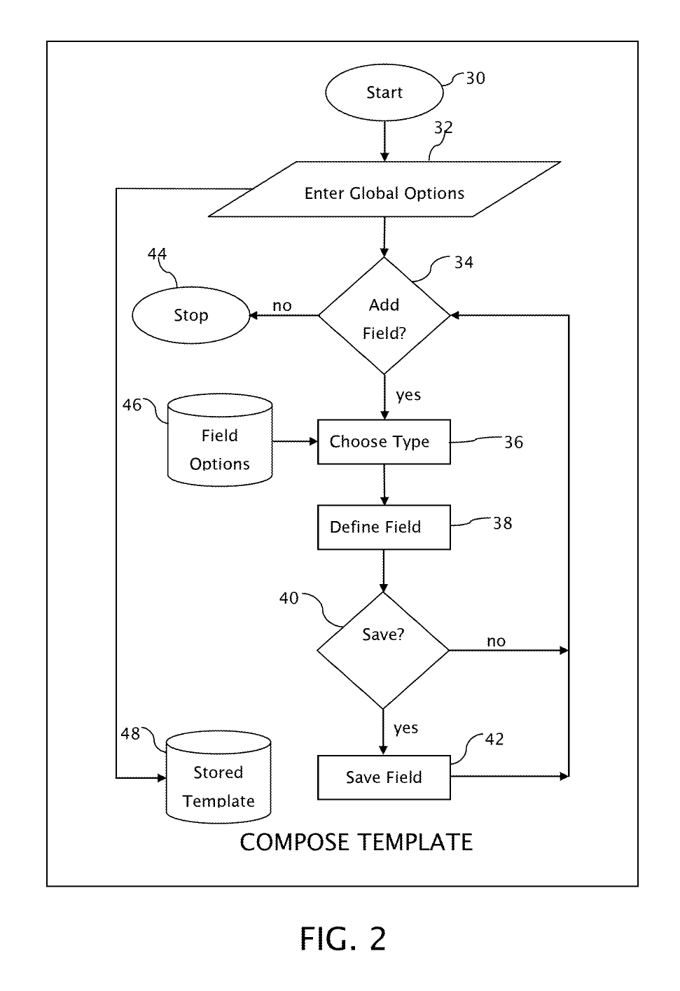

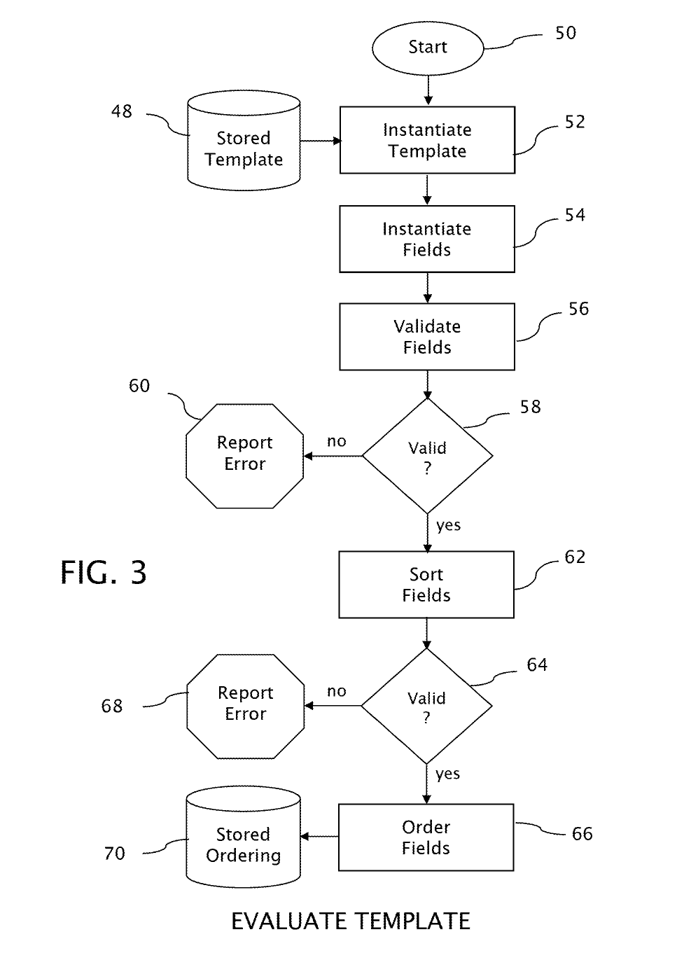

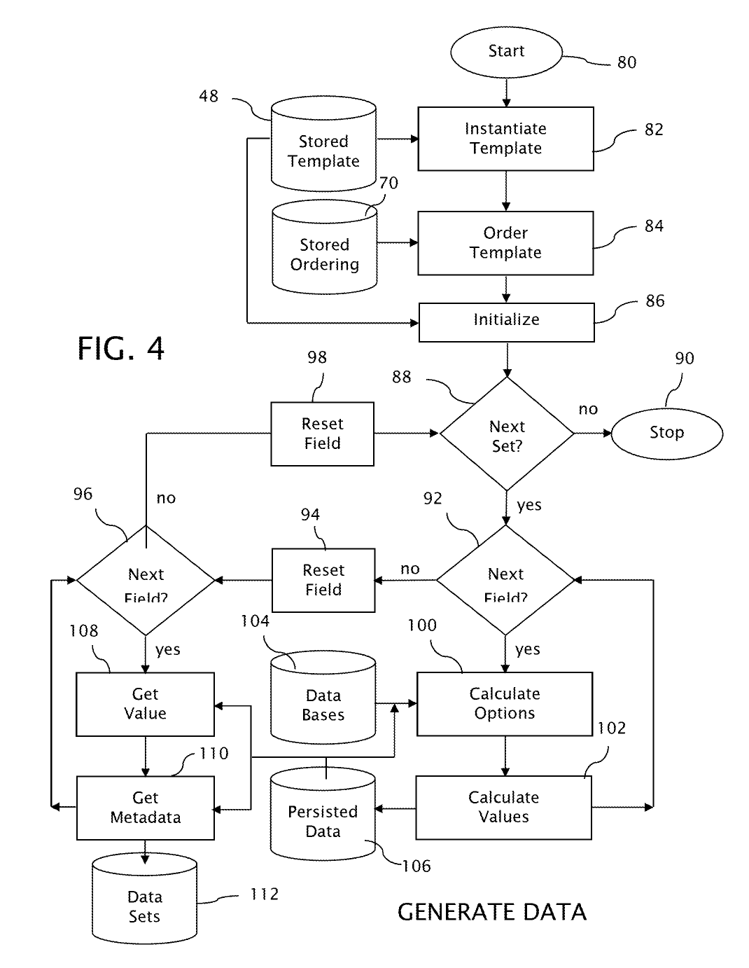

FIG. 2 presents a processing layout of the composition module 16 (see FIG. 1) for creating a new data generation template. Following the start 30 of a routine that is intended for creating a new data generation template and that is supported by a computer processor, global information is added at step 32 specifying (a) the intended output format for the generated data, such as HTML (HyperText Markup Language), Auto DTD (Document Type Definition) input, CSV (Comma Separated Values), or LM-DRIS Truth (Lockheed Martin Decennial Response Integration System) (b) the number of datasets to be generated, and (c) global data descriptions. A screen shot for starting a new template is shown in FIG. 3, and a screen shot for inputting global information is shown in FIG. 4. The global data descriptions presented under the heading “Template Options” include a choice of country, a choice of language, and a choice of filter options. The options depicted are, of course, examples, and many other choices can be provided for globally characterizing the data, including specifying domain-specific data such as Census data, Internal Revenue Service data, or electronic medical records, or financial records including transaction auditing. Once selected, the global data descriptions are stored in a data base as a part of the stored template 46.

A series of steps 34 through 42 provide for generating individual fields of the template. Step 34 queries whether a new field is to be added to the template. Each new field can be considered a row of the template. If yes, processing proceeds to step 36 for choosing the type of field. If no, processing stops, the template is considered complete. After choosing the field type, step 38 provides for defining the field including any field parts. Of course, provisions can be made for editing the fields of existing templates where existing choices can be changed. In addition, the field can be grouped with other specified fields, and resulting data can be hidden from the output or rendered constant. Individual fields can be assigned to a group so that specific operations addressing the individual fields can be extended to collectively address a group of fields. If the data is intended to represent the content of a form, the page of the form can be specified. Explanatory comments can also be saved.

The choice of data type opens a new level of options for further defining the data type, including the ability to specify or apply predetermined rules and constraints. The data types are drawn from a database of field options 46. Custom text file lists of names representative of particular populations (including particular names and the frequency with which the particular names occur within the represented population) can be added to the library data base using a conventional tools utility. The custom test file is then among the files that can be chosen from the library data base for sourcing the first, middle, or last names.

Each field or field part can be defined by exercising options provided by predefined data types. The options for each data type, which can be understood as data control “knobs”, provide for (a) sourcing the data, such as from library data bases, custom lists, random number generators, or other fields, (b) relating data among the other fields or field parts within the template for internal consistency, and (c) achieving statistical validity over distributions of the sourced data between different datasets or records (i.e., over multiple instances in which the template is populated). Thus, internally consistent, realistic data can be generated by matching the sourcing, internal consistency, and statistical validity to known attributes of actual data within particular data domains.

Once the last field is defined and saved, the template is complete and processing stops as shown at step 44 in the flow chart of FIG. 2. Once defined as an existing template, the template is accessible for later modification, update, or further development. For example, the template can be further developed to better correspond to actual data within a particular domain or to construct new data processing tests for detecting or otherwise managing anomalies within the data.

An XML representation of a two-person household template is given below:

<template content=“rules,options” name=“demo”
guid=“950e9995bd70931b780ebd5972eb31b7” version=“1.0”>

<last_generation_options/>
<fields>

<field id=“1” name=“Person 1” type=“Person” hidden=“false” constant=“false”
page=“” removed=“false” comments=“”>

<options>

<option user=“default” name=“cap_upper”>false</option>
<option user=“default” name=“cap_lower”>false</option>
<option user=“default” name=“cap_first”>false</option>
<option user=“default” name=“cap_uword”>false</option>
<option user=“default” name=“cap_random”>false</option>
<option user=“default” name=“cap_per_upper”/>
<option user=“default” name=“cap_per_lower”/>
<option user=“default” name=“cap_per_first”/>
<option user=“default” name=“cap_per_uword”/>
<option user=“default” name=“cap_per_random”/>
<option user=“default” name=“example”/>

</options>

</field>
<field id=“2” name=“Person 2” type=“Person” hidden=“false” constant=“false”
page=“” removed=“false” comments=“”>

<options>

<option user=“default” name=“cap_upper”>false</option>
<option user=“default” name=“cap_lower”>false</option>
<option user=“default” name=“cap_first”>false</option>
<option user=“default” name=“cap_ uword”>false</option>
<option user=“default” name=“cap_random”>false</option>
<option user=“default” name=“cap_per_upper”/>
<option user=“default” name=“cap_per_lower”/>
<option user=“default” name=“cap_per_first”/>
<option user=“default” name=“cap_per_uword”/>
<option user=“default” name=“cap_per_random”/>
<option user=“default” name=“example”/>

</options>

</field>
<field id=“3” name=“Person 1 Age” type=“Number-Range” hidden=“false”
constant=“false” page=“” removed=“false” comments=“”>

<options>

<option user=“default” name=“numRangeMin”>30</option>
<option user=“default” name=“numRangeMax”>100</option>
<option user=“default” name=“constrainMode_CB”>false</option>
<option user=“default” name=“numRangeMode”/>
<option user=“default” name=“resultPadding”>false</option>
<option user=“default” name=“resultPadLength”/>
<option user=“default” name=“resultPadChar”/>
<option user=“default” name=“resultPadLeft”>true</option>
<option user=“default” name=“min_relFreq”>2.5</option>
<option user=“default” name=“max_relFreq”>2.5</option>
<option user=“default” name=“cp1_relFreq”>5.0</option>
<option user=“default” name=“example”/>

</options>

</field>
<field id=“4” name=“Person 2 Age” type=“Bounded-Number-Range”
hidden=“false” constant=“false” page=“” removed=“false” comments=“”>

<options>

<option user=“default” name=“offset”>true</option>
<option user=“default” name=“resultPadding”>false</option>
<option user=“default” name=“range_min”>MinField</option>
<option user=“default” name=“range_max”>MaxField</option>
<option user=“default” name=“offset_op”>Sub</option>
<option user=“default” name=“testResultGoalMin”>1</option>
<option user=“default” name=“testResultGoalFieldMin”>3</option>
<option user=“default” name=“testResultGoalMax”>10</option>
<option user=“default” name=“testResultGoalFieldMax”>3</option>
<option user=“default” name=“offsetNumRangeMin”>28</option>
<option user=“default” name=“offsetNumRangeMax”>40</option>
<option user=“default” name=“resultPadLength”/>
<option user=“default” name=“resultPadChar”/>
<option user=“default” name=“example”/>

</options>

</field>
<field id=“5” name=“Person 1 Last Name” type=“MultiValueFieldAccessor”
hidden=“false” constant=“false” page=“” removed=“false” comments=“”>

<options>

<option user=“default” name=“field”>1</option>
<option user=“default” name=“mvdfSelectionOption”>Person</option>
<option user=“default” name=“option”>LastName</option>
<option user=“default” name=“example”/>

</options>

</field>
<field id=“6” name=“Person 2 Last Name” type=“MultiValueFieldAccessor”
hidden=“false” constant=“false” page=“” removed=“false” comments=“”>

<options>

<option user=“default” name=“field”>1</option>
<option user=“default” name=“mvdfSelectionOption”>Person</option>
<option user=“default” name=“option”>LastName</option>
<option user=“default” name=“example”/>

</options>

</field>

</fields>

</template>

The fields used for constructing the template can be defined to hold, in addition to their specified constraints or rules, single or multiple data elements. Simple fields, such as “Person 1 Age” and “Person 1 Last Name”, each contain a single field part holding a single data element. Multi-value fields each contain a plurality of field parts collectively holding multiple data elements. Within the multi-value fields, the multiple field parts can define parts of integrated data structures, such as a full name (e.g., the “Person” type field of the above example), which can include field parts holding separate values for first name, middle name, and last name. The “Multiple Value Field Accessor” data type extracts values from specified field parts of the multi-value fields.

A plurality of simple or multi-value fields can be combined within a template or otherwise integrated to form a so-called super field. For example, a “Household” super field can contain internally consistent data associated with collections of persons that might live together within a single residence, including families with parents and children. The included multi-value fields within the “Household” super field can contain, for example, full names of persons (first, middle and last names), an address of the household (e.g., house number, apartment number, street, city, state, and zip code), and a telephone number of the household (e.g., area code, exchange, number). In addition, the “Household” super field can include a plurality of single value fields containing information about the race, ethnicity, and occupations of the household members.

For example, a single “Household Structure” data type of a super field can contain a large number of pre-related field parts containing the data described above as well as fields for formatting the data and choosing the number of household members and familial relationships among the members. As a part of the “household” super field, the user can select the field part “population” for defining the minimum and maximum number of members in the households (i.e., household size) and the relative frequencies at which the different size households occur within the total number of households to be generated. Familial relationships among the persons of the house can be assigned by choosing among valid combinations of familial relationships with different numbers of members according to a predetermined frequency distribution.

The super field can also include a plurality of predefined and pre-related field parts such as established for last name and age for the two-person household of the “demo” template. The super field can also be combined with other multi-value or single value fields within a template, especially fields with a “Multiple Value Field Accessor” data type for extracting and manipulating data held by the super field for generating output datasets.

For example, the rules and constraints imposed upon the field parts of the super field produce a fully self-consistent collection of attributes appropriate to a randomly selected typical household within the given population. More specific connections between the household members can be established by using additional fields make assignments between the attributes of the household (i.e., relate data within the “Household” field parts). As these assignments are made, consistency logic can be incorporated to alter those attributes that are not being explicitly set, but which must for consistency maintain a given relationship with respect to an attribute being assigned, so that the full collection of attributes provided by “Household” super field for each household member and for the household overall are maintained.

Error checking, not explicitly shown, can be incorporated within the composition of the template to identify inconsistencies or contradictions within the rules or constraints applied. Depending on the type of error as the error might affect the realism or more fundamental logical construction of the data, provisions can be made for rejecting field definitions or flagging potential problems.

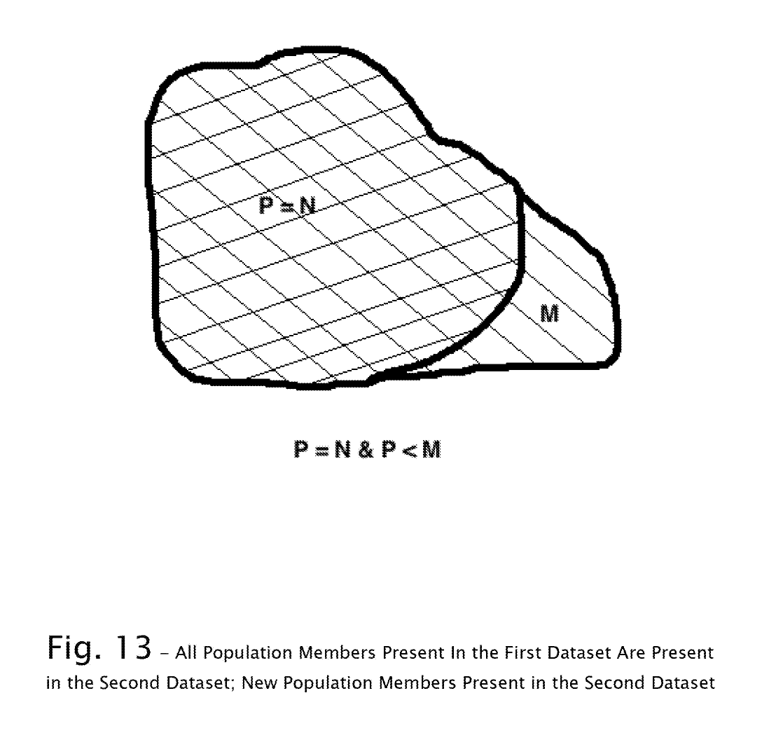

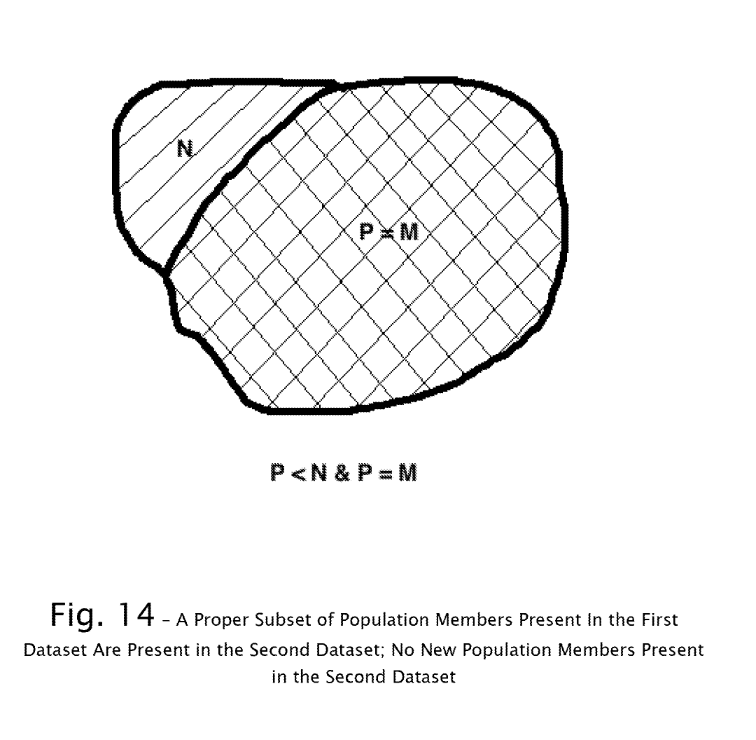

A more thorough evaluation of the composed template is performed by the evaluation module 20 (see FIG. 1) that is automatically invoked by a command to generate data (see “GENERATE DATA” button in FIG. 13). A procedure for evaluating the template is depicted in FIG. 3. Starting at step 50, the evaluation module instantiates at step 52 the template drawn from the data store 18 containing the stored template 48. At step 54, the fields within the template are instantiated. Once residing in a processable form, the fields are validated individually for inconsistencies or contradictions at step 56. At step 58, a decision is made before proceeding further as to whether the fields in the template are valid or not. If all of the fields are not individually valid processing stops at step 60 and a descriptive error message is posted. If all of the fields are individually valid, a sort routine is invoked at step 62.

Within the sort routine, the fields within the template are ordered so that for any given field, the fields on which the given field depends will be evaluated before the given field is evaluated. That is, the “used” field should be ordered before the “using” field. Equivalently, if a field modifies a value (such as in an IF-THEN conditional data type), the modifying field must be invoked after the modified field is calculated so that the natural calculation of the modified field does not overwrite the modifying field's results. As a first step within the sort algorithm, interdependent fields are grouped together. Next, a “must-follow” list is formed for each of the fields within the group according to the principles outlined above (i.e., for each field a list of fields that must be evaluated first). A topological sort of the fields is performed within the group. Successive groups of interdependent fields are sorted similarly until all of the fields within the template are sorted in order. The field parts within a super field are preferably presorted as if the field parts were fields arranged within an independent template.

Once a sort order is established, the new field order is tested at step 64 for overall logical consistency, particularly for identifying any circular dependencies. If the sort order evaluates as valid, the order of the fields is finalized at step 66 and the sort order is stored in the data store 18 as the stored ordering 70.

The generation module 22 (see FIG. 1) also draws from the data store 18, starting at step 80 as shown in FIG. 4 for instantiating the template at step 82 based on the stored template 48 produced by composition module 16 and ordering the fields within the template at step 84 based on the stored ordering 70 produced by the evaluation module 20. At the following step 86, the instantiated and ordered template is initialized drawing on the global template options, which were also saved as a part of the stored template 48.

Nested iteration loops executed within the generation module provide for populating and retrieving selected data from the ordered fields within the template for creating individual datasets and for populating a succession of datasets according to the selected global option specifying the number of records to be generated. At decision step 88 of an outer iteration loop, processing continues within the outer loop if another dataset remains to be populated to satisfy the global specification for the number of records to be generated (i.e., next set—yes). Once all of the required records are generated (i.e., next set—no), processing stops at step 90. At decision step 92 of a first inner iteration loop, processing continues within the first inner loop if another field within a dataset remains to be populated (i.e., next field—yes). Once all the ordered fields of the template have been populated (i.e., next field—no), a field count within the template is reset at step and processing proceeds to a decision step 96 of a second inner iteration loop for retrieving specified data from each of the fields to assemble an individual dataset. Processing continues within the second inner iteration loop if data remains to be retrieved from one of the fields (i.e., next field—yes). Once the specified data has been retrieved from all of the fields (i.e., next field—no), the field count is again reset at step 98 and control is returned to the outer iteration loop at decision step 88.

Within the first inner iteration loop, a calculate options step 100 passes the generation options for an individual field (i.e. the instructions for acquiring data). A calculate values step 102 populates the one of more field parts of the individual field with values according to the options passed in the preceding step and saves the results in persistent data 106. The calculate options step 100 makes the necessary connections with library data bases 104 or previously populated fields within the persistent data 106 for populating the one of more field parts of the individual field. In addition to populating the fields with values, the fields are also populated with metadata, which is preferably created each time a rule or constraint is invoked. The metadata can identify the rules invoked as well as results of the rules invoked. For example, the metadata can identify the lists (e.g., data bases) from which the data is sourced, the logical outcomes of conditional tests, the statistical distributions matched, and the truth values of data, particularly for event tags associated with deliberately engineered errors or specially planted data.

Within the second inner iteration loop, a get value step 108 retrieves selected data from one or more populated field parts of an individual field, and a get metadata step 110 retrieves selected descriptive matter in the form of metadata characterizing the selected data. Both the selected data and the metadata are stored for assembling the desired datasets 112. Selected data and metadata is not necessarily retrieved from each field in the template. Some fields hold hidden data, such as intermediate data useful for interrelating or calculating final results in other fields.

The succession of steps within the second inner iteration loop retrieve selected data and metadata from individual fields and the succession of loops performed by the second inner iteration loop populate an individual dataset (i.e., an individual record). Multiple datasets (multiple records) are assembled by repopulating the fields through the first inner iteration loop and retrieving selected data and metadata from the repopulated fields through the second inner iteration loop as both loops are reset and indexed within the outer iteration loop that counts the datasets. The generated datasets can be individually written into computer-readable memory as the datasets 112 are retrieved or collectively written into computer-readable memory in one or more groups of the retrieved datasets.

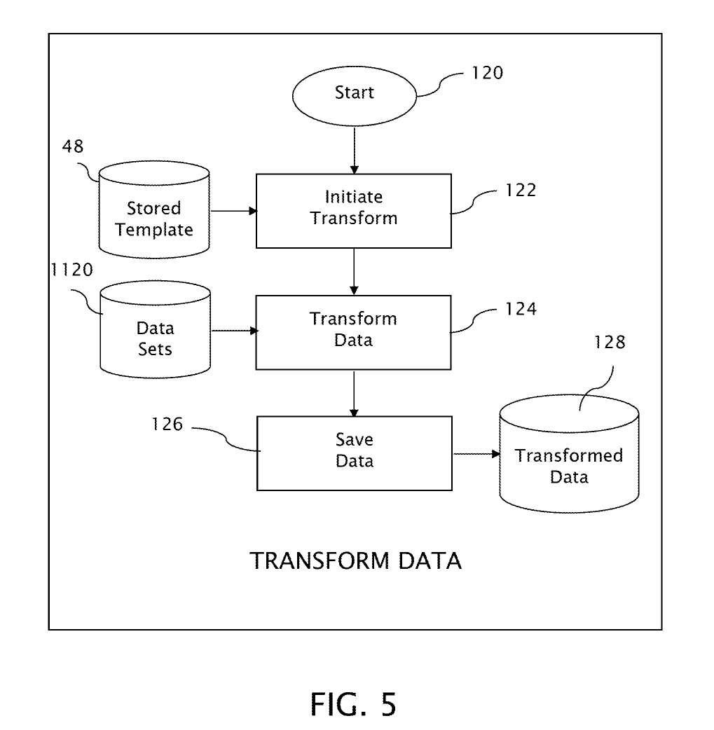

The transformation module 24 (see FIG. 1) also accesses the data store 18 for retrieving global data generation options within the stored template 48 as well as the datasets 112 produced by the generation module 22. Starting at step 120 in the transform data flowchart of FIG. 5, the transformation module 24 initiates the desired transform at step 122 based on the data generation options within the stored template 48. At step 124 the store datasets 112 are transformed from a generic representation into one or more specific representations in accordance with the intended use of the generated data as specified by the data generation options. The generated datasets in the specified representation is saved at step 126 into the data store 18 (see FIG. 1) as transformed data 128, which is accessible through the graphical interface 14 to the communication interface 12 for downloading. The data store 18 preserves data in a form of computer-readable memory and this memory is altered each time data is written into the data store 18 from one of the system modules, including the composition module 16, which writes the stored template 48, the evaluation module 20, which writes the stored ordering 70 of the template, the generation module 22, which writes the datasets 112, and the transformation module 24, which writes the transformed data 128 that is downloadable as synthetic data. The various modules 16, 20, 22, and 24, as arranged to perform their specific functions, can be localized on one computer or distributed between two or more computers. The transformed data 128 can be viewed in table form through the graphical interface 14 or saved remotely through the communication interface 12 in preparation for its intended use.

The files downloaded from the synthetic data generation system 10 can be used directly for testing or analyzing automated document processing systems or data mining operations. Alternatively, the files can be further converted or incorporated into predetermined data structures such as forms that are reproducible in paper or as electronic images. For example, the synthetic data can be formatted to represent handwritten text appearing on data forms as shown and described in U.S. Pat. No. 8,498,485 entitled Handprint Recognition Test Deck and US Patent Application Publication No. 2008/0235263 entitled Automating Creation of Digital Test materials, with both the immediately referenced patent and application publication being hereby incorporated by reference.

The synthetic data generator 10 as described above allows for the generation of increasingly sophisticated data including the ability to provide domain-specific context-sensitive data collections that can accurately mimic real data collected for processing. The increasing sophistication can be achieved by defining data fields in logical relations with one another within a first stage template structure and combining the multiple data fields in the first stage template structure into a single multi-value field within a second stage template structure in which the single multi-value field includes corresponding field parts that are similarly constrained for validity and internal consistency. Multiple stage templates can be assembled in this progression. For example, the multiple parts of persons names, addresses, and telephone numbers can each be combined into single multi-value fields for name, address, and telephone number, and the multi-value fields for name, address, and telephone number can be combined together with other relational fields into a single multi-value field for household (such multi-generational multi-value fields being referred to as super fields). Once a super field is defined, such as for capturing the many parameters of a household, additional fields can be added to append to and further refine relationships within the household or variations between the households for better matching statistical distributions or other definable trends within a modeled domain.

The increasing sophistication is also made possible by separately defining the output responses of the individual single and multi-value fields. Not all of the data populating individual fields necessarily contribute to the output dataset. Many fields and field parts hold intermediate data used for generating other data or is rendered obsolete by the rules and specifications of other fields. For example, the field part for last name in the multi-value field for the full name of the second person of the household is replaced by the last name in the multi-value field for the full name of the first person of the household. The originally downloaded last name for the second person in the household is still retained within the populated fields of the template, but does not appear in the datasets generated by the template. The super field, “Household”, although containing numerous field parts may report (i.e., contribute to the generated dataset) only a single number each time poled, such as the number of persons in the household, with the other values held within the super field “Household” remaining unused or superseded by the values reported from other fields of the template. In addition, not all of the data that is extractable from the template fields, particularly the multi-value fields (super fields), may be required for particular applications under test, but the additional predefined relationships among the fields and field parts can provide a previously substantiated reservoir from which to draw new synthetic data.

While the generation of realistic internally consistent data is an overarching goal in most instances, the synthetic data generator 10 also provides for the incorporation of deliberately engineered errors or other anomalies within the synthetic data. The metadata, which can accompany the values reported from the template fields, can provide, as a part of the description of the values, an indication of the departure of particular values from known or expected standards or truths. For example, deliberate inconsistencies can be incorporated into the generated datasets with the presence of the inconsistent data flagged by the metadata within the generated datasets.

Event tags can be assigned in metadata to track events that occur during the generation of data for conditional data type fields. The event tags attach to the conditional data type fields and are retrievable in place of or in conjunction with any values reported by the conditional data type fields. The statements can be arranged to affect the values in individual fields or to collectively affect the values in a group of fields. Additional details of a synthetic data generator appropriate for purposes of various embodiments is found in U.S. Pat. No. 8,862,557 issuing on Oct. 14, 2014 to Glasser et al., which patent is hereby incorporated by reference to incorporate such details.

One the synthetic data generation process has been completed, the further generation of internally consistent data can be resumed based on the previously imposed logical and statistical relationships set by the template and embodied in the already generated data. For example, temporal parameters can be changed to resume the generation of internally consistent data within any imposed time frame preceding, overlapping, or following the temporal parameters initially set.

### Problem 1

### Continuing a Dataset

It is sometimes useful to create a synthetic second dataset which is a temporal extension of a first dataset. For the second dataset, it is desirable that at the start of its observation window at least a subset of the population has characteristics that are consistent with events and histories present in the first dataset at the end of the first dataset observation window. For the EHR example, above, characteristics would include demographics, such as a patient's ethnicity. Histories would include everything relevant that has occurred to the patient, such as “had measles” or “previously went to Dr. X for diabetes condition.”

### Problem 1

### Preferred Embodiments

### Embodiment 1

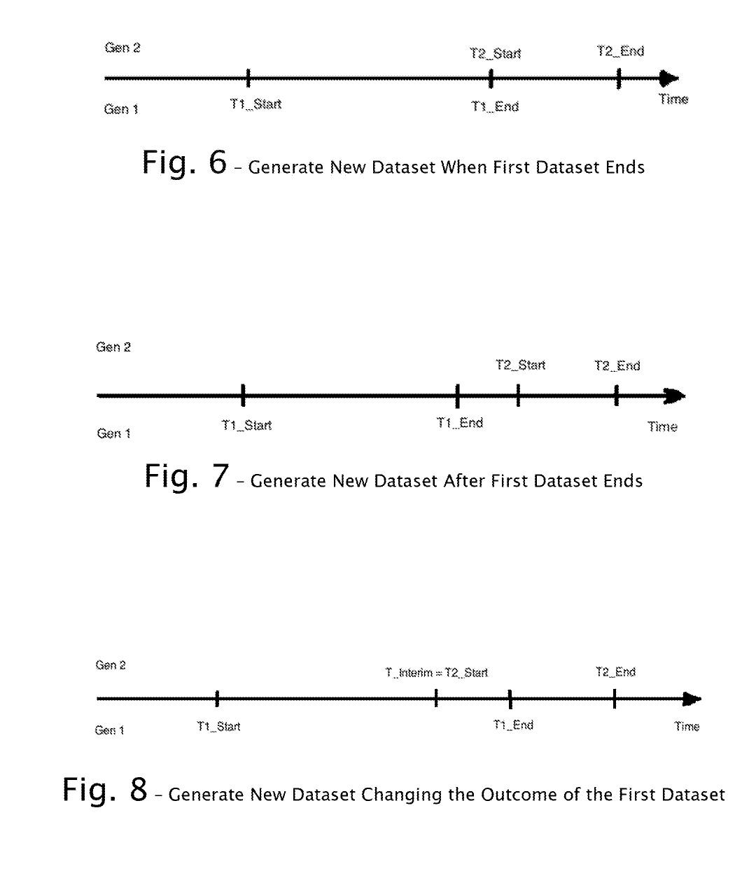

With reference to FIG. 6, generate new dataset at the time that a first observation window ended:

Given a first dataset based on an observation window that ends at time T₁_{_}_{End}, based on a population of N entities as of time T₁_{_}_{End}, and for each member of the population there are associated characteristics and histories as of time T₁_{_}_{End}, a second synthetic dataset is generated
with an observation window that starts at time T₂_{_}_{Start}=T₁_{_}_{End};
based on a population of M entities as of time T₂_{_}_{Start}; and,
within the population of M entities there exist at least P distinct entities (P<=N and P<=M) where each of the P entities has characteristics and histories as of time T₂_{_}_{Start} that are equivalent to those from a distinct member of the first dataset as of time T₁_{_}_{End}.

### Embodiment 2

With reference to FIGS. 6 and 12, generate new dataset at the time that a first observation window ended (all population members present in the first dataset at time T₁_{_}_{End} are present in the second dataset at time T₂_{_}_{Start}, no new population members present in the second dataset at time T₂_{_}_{Start}):

The arrangement of Embodiment 1 where P=N and P=M.

### Embodiment 3

With reference to FIGS. 6 and 13, generate new dataset at the time that a first observation window ended (all population members present in the first dataset at time T₁_{_}_{End} are present in the second dataset at time T₂_{_}_{Start}, new population members present in the second dataset at time T₂_{_}_{Start}):

The arrangement of Embodiment 1 where P=N and P<M.

### Embodiment 4

With reference to FIGS. 6 and 14, generate new dataset at the time that a first observation window ended (proper subset of population members present in the first dataset at time T₁_{_}_{End} are present in the second dataset at time T₂_{_}_{Start}, no new population members present in the second dataset at time T₂_{_}_{Start}):

The arrangement of Embodiment 1 where P<N and P=M

### Embodiment 5

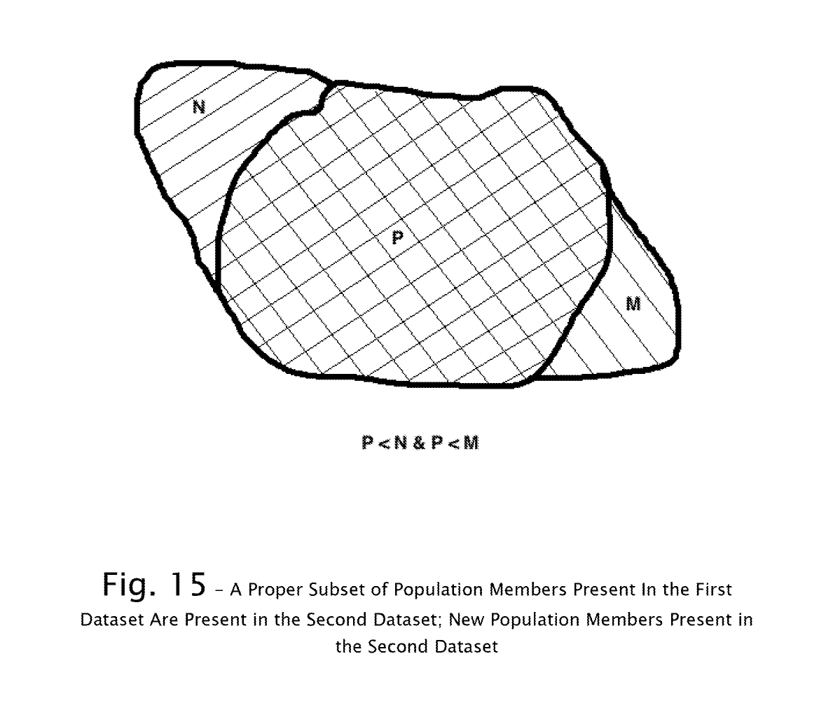

With reference to FIGS. 6 and 15, generate new dataset at the time that a first observation window ended (proper subset of population members present in the first dataset at time T₁_{_}_{End} are present in the second dataset at time T₂_{_}_{Start}, new population members present in the second dataset at time T₂_{_}_{Start}):

The arrangement of Embodiment 1 where P<N and P<M.

### Embodiment 6

With reference to FIG. 7, generate new dataset at a time later than when a first observation window ended:

Given a first dataset based on an observation window that ends at time T₁_{_}_{End}, based on a population of N entities as of time T₁_{_}_{End}, and for each member of the population there are associated characteristics c_{i,1}_{_}_{End} and histories h_{i,1}_{_}_{End} as of time T₁_{_}_{End}, a second dataset is generated
with an observation window that starts at time T₂_{_}_{Start}>T₁_{_}_{End};
based on a population of M entities as of time T₂_{_}_{Start}; and,
within the population of M entities there exist at least P distinct entities (P<=N and P<=M) at time T₂_{_}_{Start} where each entity Pi from the population of P distinct entities has characteristics c_{i,2}_{_}_{Start}=f_{C}(c_{i,1}_{_}_{End}) and histories h_{i,2}_{_}_{Start}=f_{H}(h_{i,1}_{_}_{End}) where f_{C}( ) and f_{H}( ) represent functions that transform, respectively, characteristics and histories for an entity from time T₁_{_}_{End} to time T₁_{_}_{Start}.

### Embodiment 7

With reference to FIGS. 7 and 12, generate new dataset at a time later than a first observation window ended (all population members present in the first dataset at time T₁_{_}_{End} are present in the second dataset at time T₂_{_}_{Start}, no new population members present in the second dataset at time T₂_{_}_{Start}):

The arrangement of Embodiment 6 where P=N and P=M.

### Embodiment 8

With reference to FIGS. 7 and 13, generate new dataset at a time later than a first observation window ended (all population members present in the first dataset at time T₁_{_}_{End} are present in the second dataset at time T₂_{_}_{Start}, new population members present in the second dataset at time T₂_{_}_{Start}):

The arrangement of Embodiment 6 where P=N and P<M.

### Embodiment 9

With reference to FIGS. 7 and 14, generate new dataset at a time later than a first observation window ended (proper subset of population members present in the first dataset at time T₁_{_}_{End} are present in the second dataset at time T₂_{_}_{Start}, no new population members present in the second dataset at time T₂_{_}_{Start}):

The arrangement of Embodiment 6 where P<N and P=M.

### Embodiment 10

With reference to FIGS. 7 and 15, generate new dataset at a time later than a first observation window ended (proper subset of population members present in the first dataset at time T₁_{_}_{End} are present in the second dataset at time T₂_{_}_{Start}, new population members present in the second dataset at time T₂_{_}_{Start}):

The arrangement of Embodiment 6 where P<N and P<M.

### Embodiment 11

With reference to FIG. 7, generate new dataset at a time later than a first observation window ended (the first dataset populations members present in the second dataset have the same characteristics at the start of the second dataset observation window as they had at the end of the first dataset observation window):

The arrangement of Embodiment 6 where f_{C}( ) is the identity transformation.

### Embodiment 12

With reference to FIG. 7, generate new dataset at a time later than a first observation window ended (the first dataset populations members present in the second dataset have the same histories at the start of the second dataset observation window as they had at the end of the first dataset observation window):

The arrangement of Embodiment 6 where f_{H}( ) is the identity transformation.

### Problem 2

### Changing the Outcome of a Dataset

It is sometimes useful to create a second dataset that replaces the contents of a first dataset starting at a given time contained within the observation window for the first dataset. For the second dataset, it is desirable that at the start of its observation window at least a subset of the population has characteristics that are consistent with events and histories present within the first dataset at the given time.

### Problem 2

### Preferred Embodiments

### Embodiment 13

With reference to FIG. 8, generate new dataset at a time within a first observation window:

Given a first dataset based on an observation window that starts at time T₁_{_}_{Start} and ends at time T₁_{_}_{End}, an interim time Tᵢₙₜₑᵣᵢₘ where T₁_{_}_{Start}<Tᵢₙₜₑᵣᵢₘ<T₁_{_}_{End}, based on a population of Nᵢₙₜₑᵣᵢₘ entities as of time Tᵢₙₜₑᵣᵢₘ, and for each member of the population there are associated characteristics c_{i,interim} and histories h_{i,interim} as of time Tᵢₙₜₑᵣᵢₘ, a second dataset is generated
with an observation window that starts at time T₂_{_}_{Start}=Tᵢₙₜₑᵣᵢₘ;
based on a population of M entities as of time T₂_{_}_{Start}; and,
within the population of M entities there exist at least P distinct entities (P<=Nᵢₙₜₑᵣᵢₘ and P<=M) where each of the P entities has characteristics and histories as of time T₂_{_}_{Start} that are equivalent to those from a distinct member of the first dataset as of time Tᵢₙₜₑᵣᵢₘ.

### Embodiment 14

With reference to FIGS. 8 and 12, generate new dataset at a time within a first observation window (all population members present in the first dataset at time Tᵢₙₜₑᵣᵢₘ are present in the second dataset at time T₂_{_}_{Start}, no new population members present in the second dataset at time T₂_{_}_{Start}):

The arrangement of Embodiment 13 where M=Nᵢₙₜₑᵣᵢₘ=P.

### Embodiment 15

With reference to FIGS. 8 and 13, generate new dataset at a time within a first observation window (all population members present in the first dataset at time Tᵢₙₜₑᵣᵢₘ are present in the second dataset at time T₂_{_}_{Start}, new population members present in the second dataset at time T₂_{_}_{Start}):

The arrangement of Embodiment 13 where M>Nᵢₙₜₑᵣᵢₘ and P=Nᵢₙₜₑᵣᵢₘ.

### Embodiment 16

With reference to FIGS. 8 and 14, generate new dataset at a time within a first observation window (proper subset of population members present in the first dataset at time Tᵢₙₜₑᵣᵢₘ are present in the second dataset at time T₂_{_}_{Start}, no new population members present in the second dataset at time T₂_{_}_{Start}):

The arrangement of Embodiment 13 where M<Nᵢₙₜₑᵣᵢₘ and P=M.

### Embodiment 17

With reference to FIGS. 8 and 15, generate new dataset at a time within a first observation window (proper subset of population members present in the first dataset at time Tᵢₙₜₑᵣᵢₘ are present in the second dataset at time T₂_{_}_{Start}, new population members present in the second dataset at time T₂_{_}_{Start}):

The arrangement of Embodiment 13 where M>P and P<Nᵢₙₜₑᵣᵢₘ.

### Problem 3

### Preceding a Dataset

It is sometimes useful to create a second dataset which is a temporal predecessor of a first dataset. For the second dataset, it is desirable that at the end of its observation window at least a subset of the population has characteristics that are consistent with events and histories present in the first dataset at the start of the first dataset observation window.

### Problem 3

### Preferred Embodiments

### Embodiment 18

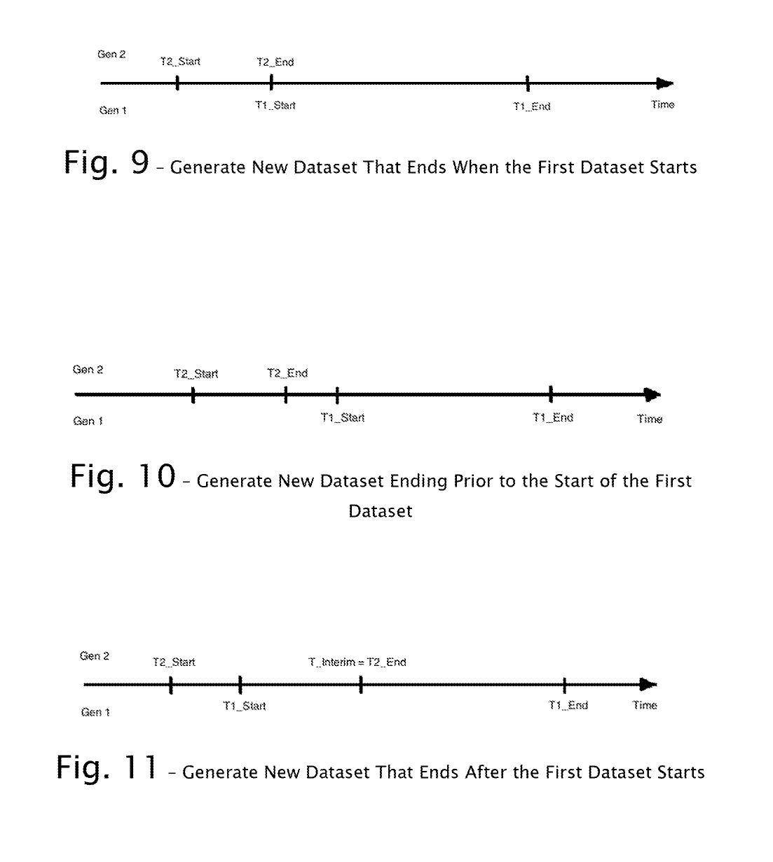

With reference to FIG. 9, generate a new dataset that ends at the time when a first observation window started:

Given a first dataset with an observation window that begins at time T₁_{_}_{Start}, based on a population of N entities as of time T₁_{_}_{Start}, and for each member of the population there are associated demographics d_{i,1}_{_}_{Start} and histories h_{i,1}_{_}_{Start} as of time T₁_{_}_{Start}, a second dataset is generated
with an observation window that ends at time T₂_{_}_{End}=T₁_{_}_{Start};
based on a population of M entities as of time T₂_{_}_{End}; and,
within the population of M entities there exist at least P distinct entities (P<=N and P<=M) where each of the P entities has characteristics and histories as of time T₂_{_}_{End} that are equivalent to the those from a distinct member of the first dataset as of time T₁_{_}_{Start}

### Embodiment 19

With reference to FIGS. 9 and 12, generate a new dataset that ends at the time when a first observation window started (all population members present in the first dataset at time T₁_{_}_{Start} are present in the second dataset at time T₂_{_}_{End}, no new population members present in the second dataset at time T₂_{_}_{End}).

The arrangement of Embodiment 18 where P=N and P=M.

### Embodiment 20

With reference to FIGS. 9 and 13, generate a new dataset that ends at the time when a first observation window started (all population members present in the first dataset at time T₁_{_}_{Start} are present in the second dataset at time T₂_{_}_{Start}, new population members present in the second dataset at time T₂_{_}_{End}).

The arrangement of Embodiment 18 where P=N and P<M.

See FIGS. 4 and 8.

### Embodiment 21

With reference to FIGS. 9 and 14, generate a new dataset that ends at the time when a first observation window started (proper subset of population members present in the first dataset at time T₁_{_}_{Start} are present in the second dataset at time T₂_{_}_{End}, no new population members present in the second dataset at time T₂_{_}_{End}).

The arrangement of Embodiment 18 where P<N and P=M.

### Embodiment 22

With reference to FIGS. 9 and 15, generate a new dataset that ends at the time when a first observation window started (proper subset of population members present in the first dataset at time T₁_{_}_{Start} are present in the second dataset at time T₂_{_}_{End}, new population members present in the second dataset at time T₂_{_}_{End}).

The arrangement of Embodiment 18 where P<N and P<M.

### Embodiment 23

With reference to FIG. 10, generate a new dataset that ends at a time prior to when a first observation window started:

Given a first dataset based on an observation window that begins at time T₁_{_}_{Start}, based on a population of N entities as of time T₁_{_}_{Start}, and for each member of the population there are associated demographics d_{i,1}_{_}_{Start} and histories h_{i,1}_{_}_{Start} as of time T₁_{_}_{Start}, a second dataset is generated
with an observation window that ends at time T₂_{_}_{End}<T₁_{_}_{Start};
based on a population of M entities as of time T₂_{_}_{End}; and,
and within the population of M entities there exist at least P distinct entities (P<=N and P<=M) at time T₂_{_}_{End} where each entity Pi from the population of P distinct entities has characteristics c_{i,2}_{_}_{End}=f_{C}(c_{i,1}_{_}_{Start}) and histories h_{i,2}_{_}_{End}=f_{H}(h_{i,1}_{_}_{Start}) where f_{C}( ) and f_{H}( ) represent functions that transform, respectively, characteristics and histories for an entity as of T₂_{_}_{End}

### Embodiment 24

With reference to FIGS. 10 and 12, generate a new dataset that ends at a time prior to when a first observation window started (all population members present in the first dataset at time T₁_{_}_{Start} are present in the second dataset at time T₂_{_}_{End}, no new population members present in the second dataset at time T₂_{_}_{End}).

The arrangement of Embodiment 23 where P=N and P=M.

### Embodiment 25

With reference to FIGS. 10 and 13, generate a new dataset that ends at a time prior to when a first observation window started (all population members present in the first dataset at time T₁_{_}_{Start} are present in the second dataset at time T₂_{_}_{Start}, new population members present in the second dataset at time T₂_{_}_{End}).

The arrangement of Embodiment 23 where P=N and P<M.

### Embodiment 26

With reference to FIGS. 10 and 14, generate a new dataset that ends at a time prior to when a first observation window started (proper subset of population members present in the first dataset at time T₁_{_}_{Start} are present in the second dataset at time T₂_{_}_{End}, no new population members present in the second dataset at time T₂_{_}_{End}).

The arrangement of Embodiment 23 where P<N and P=M.

### Embodiment 27

With reference to FIGS. 10 and 15, generate a new dataset that ends at a time prior to when a first observation window started (proper subset of population members present in the first dataset at time T₁_{_}_{Start} are present in the second dataset at time T₂_{_}_{End}, new population members present in the second dataset at time T₂_{_}_{End}).

The arrangement of Embodiment 23 where P<N and P<M.

### Problem 4

### Changing the Start of a Dataset

It is sometimes useful to create a second dataset that replaces the contents of a first dataset up until a given time relative to the observation window of first dataset. For the second dataset, it is desirable that at the end of the second dataset observation window at least a subset of the population has characteristics that are consistent with events and histories present in the first dataset at the given time.

### Problem 4

### Preferred Embodiments

### Embodiment 28

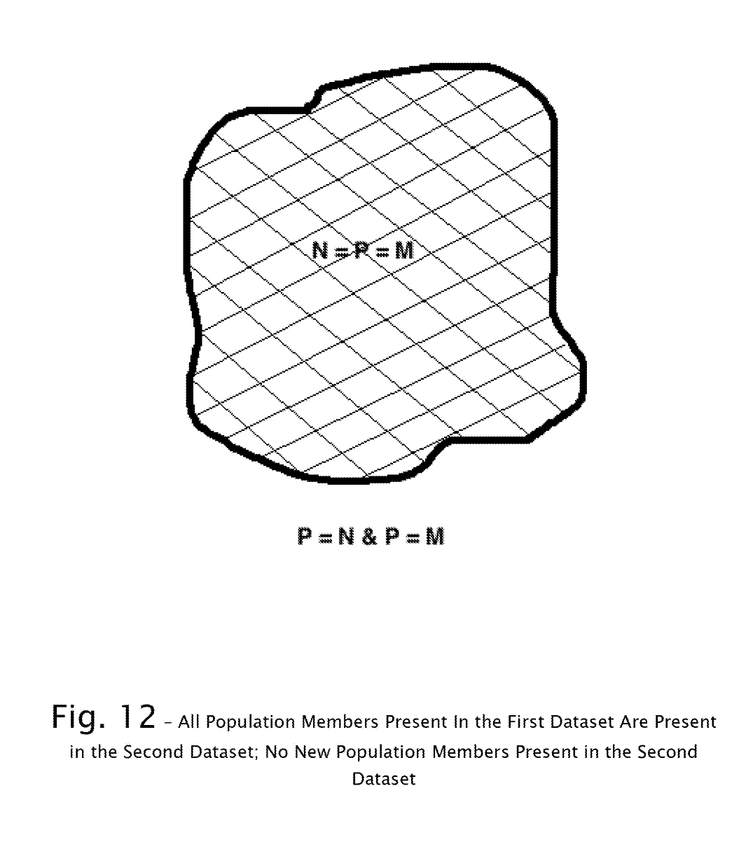

With reference to FIG. 11, generate a new dataset that ends at the time later than when a first observation window started:

Given a first dataset based on an observation window that starts at time T₁_{_}_{Start} and ends at time T₁_{_}_{End}, an interim time Tᵢₙₜₑᵣᵢₘ where T₁_{_}_{Start}<Tᵢₙₜₑᵣᵢₘ<T₁_{_}_{End}, based on a population of Nᵢₙₜₑᵣᵢₘ entities as of time Tᵢₙₜₑᵣᵢₘ, and for each member of the population there are associated characteristics c_{i,interim} and histories h_{i,interim} as of time Tᵢₙₜₑᵣᵢₘ, a second dataset is generated
with an observation window that ends at time T₂_{_}_{End}=Tᵢₙₜₑᵣᵢₘ;
based on a population of M entities as of time T₂_{_}_{End}; and,
within the population of M entities there exist at least P distinct entities (P<=Nᵢₙₜₑᵣᵢₘ and P<=M) where each of the P entities has characteristics and histories as of time T₂_{_}_{End} that are equivalent to those from a distinct member of the first dataset as of time Tᵢₙₜₑᵣᵢₘ.

### Embodiment 29

With reference to FIGS. 11 and 12, generate new dataset that ends at a time within a first observation window (all population members present in the first dataset at time Tᵢₙₜₑᵣᵢₘ are present in the second dataset at time T₂_{_}_{End}, no new population members present in the second dataset at time T₂_{_}_{End}).

The arrangement of Embodiment 28 where M=Nᵢₙₜₑᵣᵢₘ=P.

### Embodiment 30

With reference to FIGS. 11 and 13, generate new dataset at a time within a first observation window (all population members present in the first dataset at time Tᵢₙₜₑᵣᵢₘ are present in the second dataset at time T₂_{_}_{End}, new population members present in the second dataset at time T₂_{_}_{End}):

The arrangement of Embodiment 28 where M>Nᵢₙₜₑᵣᵢₘ and P=Nᵢₙₜₑᵣᵢₘ.

### Embodiment 31

With reference to FIGS. 11 and 14, generate new dataset at a time within a first observation window (proper subset of population members present in the first dataset at time Tᵢₙₜₑᵣᵢₘ are present in the second dataset at time T₂_{_}_{End}, no new population members present in the second dataset at time T₂_{_}_{End}).

The arrangement of Embodiment 28 where M<Nᵢₙₜₑᵣᵢₘ and P=M.

### Embodiment 32

With reference to FIGS. 11 and 15, generate new dataset at a time within a first observation window (proper subset of population members present in the first dataset at time Tᵢₙₜₑᵣᵢₘ are present in the second dataset at time T₂_{_}_{End}, new population members present in the second dataset at time T₂_{_}_{End}).

The arrangement of Embodiment 28 where M>P and P<Nᵢₙₜₑᵣᵢₘ.

### Problem 5

### Communicating Characteristics and Histories

In order to generate a second dataset that continues a first dataset, changes its outcome, precedes it or changes its start, it is necessary that some knowledge of the characteristics and histories of at least some subset of the entities present within the first dataset as of a given time within the observation window for the first dataset be communicated to generation software.

### Problem 5

### Preferred Embodiments

### Embodiment 33

The first dataset characteristics and histories saved from generation software for the purposes of generating the second dataset:

Given a first generated synthetic dataset based on an observation window that starts at time T₁_{_}_{Start} and ends at time T₁_{_}_{End} and a given time Tₓ, where T₁_{_}_{Start}<=Tₓ<=T₁_{_}_{End}, from which time a second dataset is to base its characteristics and histories, the dataset generation software saves to a file, database table or in memory a set of configuration and meta-data that is sufficient to allow generation software to produce a second dataset that has consistent characteristics and histories at the start or the end of its observation window.

### Embodiment 34

The first dataset characteristics and histories derived by analysis software for the purposes of generating the second dataset:

Given a first generated synthetic dataset based on an observation window that starts at time T₁_{_}_{Start} and ends at time T₁_{_}_{End} and a given time Tₓ, where T₁_{_}_{Start}<=Tₓ<=T₁_{_}_{End}, analysis software processes the first dataset to derive a set of configuration and meta-data that is sufficient to allow generation software to produce a second dataset that has consistent characteristics and histories at the start or the end of its observation window.

### Embodiment 35

The second dataset characteristics and histories a function of saved data:

A synthetic dataset is generated at least partially based on configuration and meta-data stored in a file, database table or in memory that at least partially describe the state of population entities as of a given time.

### Embodiment 36

The second dataset characteristics and histories a function of data derived by analysis of the first dataset:

A synthetic dataset is generated at least partially based on configuration and metadata derived by analysis software that processes the first dataset to derive at least partially descriptions of the state of population entities as of a given time.

Additional synthetic data based on the synthetic data in at least one of the first and second synthetic datasets can be generated within new observation windows for temporally extending or updating synthetic data from at least one of the first or second synthetic data sets. Third or subsequent observation windows can be established spanning other time periods that are different from the previously established time periods. Additional new synthetic data about the entities from the at least one of the previously generated synthetic datasets can be generated by the computer data generator within the third or subsequent observation window based on the rules loaded into the data generator and the historical information extracted from at least one of the previously generated synthetic datasets. In addition, a further set of rules can be loaded into the computer data generator for defining entities and interrelationships among events associated with the entities consistent with at least some of the rules used for generating at least one of the previously generated synthetic datasets. Entities and historical information about the entities can be derived from at least one of the prior synthetic datasets stored in a computer-readable memory.

The additional new synthetic data can be arranged in a third or subsequent synthetic dataset in a form for loading into a data processing system intended for testing using the third or subsequent synthetic dataset. The third or subsequent synthetic dataset as so arranged can include both test data intended to be processed by the data processing system and metadata defining interrelationships among the test data for evaluating performance of the data processing system.

Although described with respect to a limited number of embodiments those of skill in the art will readily recognize that absent contradiction, the various embodiments and descriptions can be combined in different ways and other modifications and adaptions will be apparent in accordance with the overall teaching of the invention. While primarily intended for use as test date for evaluating the performance of data processing systems, the synthetic datasets can also be used for other purposes including demonstrating data processing systems or for training purposes. The synthetic test data can also be converted into other forms for similar purposes, such as printed matter that might replicate other forms of input into the data processing systems.

1. A method of generating a second synthetic dataset having internal consistencies with a previously generated first synthetic dataset comprising steps of:
loading a set of rules into a computer data generator for defining entities and interrelationships among events associated with the entities consistent with at least some of the rules previously used for generating the first synthetic dataset;
deriving entities and historical information about the entities from the first synthetic dataset stored in a computer-readable memory, which historical information is generated within a first observation window spanning a first time period;
establishing a second observation window spanning a second time period that is different from the first time period; and
generating with the computer data generator new synthetic data about the entities from the first synthetic dataset within the second observation window based on the rules loaded into the data generator and the historical information extracted from the first synthetic dataset.

2. The method of claim 1 further comprising a step of arranging the new synthetic data in the second synthetic dataset in a form for loading into a data processing system intended for testing using the second synthetic dataset.

3. The method of claim 2 in which the step of arranging includes arranging in the second synthetic dataset both test data intended to be processed by the data processing system and metadata defining interrelationships among the test data for evaluating performance of the data processing system.

4. The method of claim 1 in which the first and second observation windows span contiguous intervals of time.

5. The method of claim 4 in which the second synthetic dataset is a temporal extension of the first synthetic dataset such that at a start of the second observation window, at least a subset of the entities in the second synthetic dataset has characteristics that are consistent with events and histories present in the first synthetic dataset at an end of the first observation window.

6. The method of claim 4 in which an end of the second observation window corresponds to a beginning of the first observation window such that at an end of the second observation window, at least a subset of the entities in the second synthetic dataset has characteristics that are consistent with events and histories present in the first synthetic dataset at a start of the first observation window.

7. The method of claim 1 in which the first and second observation windows span temporally separated intervals of time.

8. The method of claim 7 in which the first observation window precedes the second observation window, and at a start of the second observation window, at least a subset of the entities in the second synthetic dataset has characteristics that are consistent with events and histories present in the first synthetic dataset at an end of the first observation window.

9. The method of claim 7 in which the second observation window precedes the first observation window, and at an end of the second observation window, at least a subset of the entities in the second synthetic dataset has characteristics that are consistent with events and histories present in the first synthetic dataset at a start of the first observation window.

10. The method of claim 1 in which the second observation window overlaps a portion of the first observation window, and the second synthetic dataset replaces synthetic data of the first synthetic dataset within the overlapping portion of the first and second observation windows.

11. The method of claim 10 in which the second observation window overlaps a start of the first observation window.

12. The method of claim 10 in which the second observation window overlaps an end of the first observation window.

13. The method of claim 1 in which the entities within the second synthetic dataset exactly match the entities within the first synthetic dataset.

14. The method of claim 1 in which the second synthetic dataset includes a combination of new entities and at least a subset of the entities within the first synthetic dataset.

15. The method of claim 14 in which the second synthetic dataset includes all of the entities within the first synthetic dataset.

16. The method of claim 1 in which the second synthetic dataset includes a subset of the entities with the first synthetic dataset with no additional entities.

17. The method of claim 1 including a step of saving into a computer-readable memory a set of rules previously used by a data generator for generating the first synthetic dataset, and the step of loading includes loading at least a portion of the set of rules used for generating the first synthetic dataset.

18. The method of claim 1 including steps of:
establishing a third observation window spanning a third time period that is different from the first and second time periods; and
generating with the computer data generator additional new synthetic data about the entities from the at least one of the first and second synthetic datasets within the third observation window based on the rules loaded into the data generator and the historical information extracted from at least one of the first and second synthetic datasets.

19. The method of claim 18 further comprising steps of:
loading a further set of rules into a computer data generator for defining entities and interrelationships among events associated with the entities consistent with at least some of the rules previously used for generating at least one of the first and second synthetic datasets; and
deriving entities and historical information about the entities from at least one of the first and second synthetic datasets stored in a computer-readable memory, which historical information is generated within at least one of the first and second observation windows.

20. The method of claim 17 further comprising a step of arranging the additional new synthetic data in a third synthetic dataset in a form for loading into a data processing system intended for testing using the third synthetic dataset, wherein the step of arranging the additional new synthetic data includes arranging in the third synthetic dataset both test data intended to be processed by the data processing system and metadata defining interrelationships among the test data for evaluating performance of the data processing system.
